(19) United States
(12) Patent Application Publication
(10) Pub. No.: US 2018/0293142 A1
(43) Pub. Date: Oct. 11, 2018

(54) MULTIPLEX SYSTEM

(71) Applicant: MITSUBISHI ELECTRIC CORPORATION, Tokyo (JP)

(72) Inventor: Yasuhiro OMORI, Tokyo (JP)

(73) Assignee: MITSUBISHI ELECTRIC CORPORATION, Tokyo (JP)

(21) Appl. No.: 15/766,323

(22) PCT Filed: Dec. 3, 2015
(86) PCT No.: PCT/JP2015/083994

§ 371 Date: Apr. 5, 2018

(51) Int. Cl. G06F 11/16; G06F 11/18

(52) U.S. Cl. CPC G06F 11/1679; G06F 11/1658; G06F 11/18

(57) ABSTRACT

Each of a plurality of input units (110) outputs an input notification (104) at the input timing at which input data (101) is input and outputs input data at the synchronization timing which is the timing of the later one of the input timing and a timing at which an input notification is output from another input unit. Each of a plurality of computing units (120) starts a computation when input data output from an associated input unit is input.

### TECHNICAL FIELD

The present invention relates to a multiplex system including a plurality of processing systems.

### BACKGROUND ART

In an embedded system with high reliability, it is required to continue processing even when a trouble such as a failure occurs. Therefore, a fault tolerant design is adopted to multiplex processing systems and to continue an operation in other processing systems even when a failure occurs in any processing system.

As one of the fault tolerant designs, there is a method of detecting a processing system in which a failure has occurred, separating the detected processing system, and continuing processing in the remaining processing systems.

As a general method of determining the occurrence of a failure, there is a method of comparing computation results of each processing system. When the computation results do not match, it can be detected that a failure occurred in any of the processing systems.

In this method, it is necessary to give each processing system the same input in order to make the computation results of each processing system match in a case where no failure occurs in each processing system.

However, in a case where the processing systems perform computations at a same timing, the computation results of the processing systems would not match when the timings at which data is input to each processing system deviate from one another. To be specific, a first data is input to a first processing system before the computation timing, while the first data is input to a second processing system after the computation timing In this case, the first processing system performs a computation using the first data at a first timing, while the second processing system performs a computation without using the first data at the first timing. Therefore, the computation result of the first processing system and the computation result of the second processing system do not match with each other.

In a system of such processing systems, it is necessary to unify the timings at which data is input to each processing system.

In addition, when the timings at which computations started in each processing system are not unified, the computations executed in each processing system at the timings at which data is input differ even when the timings at which data is input to each processing system are unified. To be specific, a first processing system starts a second computation after a second data is input, while a second processing system starts a first computation after the second data is input. In this case, the first processing system uses the second data to perform the second computation, while the second processing system uses the second data to perform the first computation. Therefore, the computation results after the second data is input to the first processing system and the second processing system differ between the first processing system and the second processing system.

In a system of such processing systems, it is necessary to unify the timings at which computations are started in each processing system.

As a method of unifying the timings at which computations are started in each processing system, there are methods of making clock sources of each processing system identical as follows.

(1) A clock signal output from a single crystal oscillator is used as the clock source of each processing system. Then, each processing system operates in accordance with the clock signal output from the single crystal oscillator.

However, in this method, when a single failure occurs in the crystal oscillator, the entire system stops. In general, crystal oscillators have a higher failure rate than other ICs (Integrated Circuit). Therefore, reliability of the system lowers, and the merit of multiplexing processing systems to enable continuous operation is impaired.

(2) Clock signals synchronized by a synchronization IC are used as the clock source of each processing system. The synchronization IC synchronizes clock signals output from a plurality of crystal oscillators. Then, each processing system operates in accordance with the clock signal synchronized by the synchronization IC.

In this case, since the system has a plurality of crystal oscillators, the entire system does not stop even when a single failure occurs in the crystal oscillators. Therefore, the reliability of the system can be maintained.

However, the synchronization IC is very expensive, and thus this method cannot be applied to an embedded system where a high importance is placed on cost.

In other words, neither of the above methods (1) and (2) can be applied to ensure high reliability and to construct a system at a low cost.

Therefore, it is necessary to unify the timings at which computations are started in each processing system after providing different clock sources to each processing system and running each processing system asynchronously.

As related art which discloses a method for solving such a problem, there are Patent Literature 1 and Patent Literature 2.

In a method disclosed in Patent Literature 1, a difference in the number of clock cycles of each processing system having different clock sources is counted. Then, the difference of the number of clock cycles of each processing system is considered, and data input to each processing system and comparison of computation results of each processing system are conducted.

For example, when the operation of the second processing system is 10 clocks slower than the operation of the first processing system, it is adjusted such that the same data is input to the second processing system 10 clocks after the data is input to the first processing system. The computation result of the first processing system is compared with the computation result of the second processing system after 10 clocks.

In this way, it is possible for each of the processing systems to perform the same computation using the same data even when the processing systems are operating asynchronously. Moreover, it is possible to compare the results of the same computation of each processing system.

However, a deviation within ±100 PPM (Parts Per Million) occurs in an accuracy of a generally used crystal oscillator. That is, when a crystal oscillator of 100 MHz (megahertz) is used, a variation occurs within a range of ±1 picosecond with respect to 10 nanoseconds which is 1 clock time.

As a result, when 1 clock of the first processing system is 10 nanoseconds +1 picosecond and 1 clock of the second processing system is 10 nanoseconds −1 picosecond, a time difference of 1 microsecond occurs in one million clocks time between the first processing system and the second processing system. One million clocks are 1 second at 100 MHz. Moreover, a time difference of 3.6 milliseconds occurs in 3.6 billion clocks time between the first processing system and the second processing system. 3.6 billion clocks are one hour at 100 MHz. In other words, the longer the operation time of each processing system, the wider the time difference between the processing systems is.

In addition, in order to compare computation results of each processing system, it is necessary to retain the computation results of processing systems that process faster until the computation results of processing systems that process slower are obtained. Furthermore, when the operation time of each processing system becomes long, the amount of computation results which must be retained increases, resulting in no buffer space. Then, it becomes impossible to compare the computation results of each processing system.

In other words, when the time difference between each processing system widens, it is difficult to compare the results of the same computation of each processing system using the method disclosed in Patent Literature 1.

In a method disclosed in Patent Literature 2, a timing at which each processing system accepts data and a timing at which each processing system starts a computation are matched by transmission and reception of a synchronization command in each processing system. In this way, each processing system can perform the same computation using the same data. However, it is necessary for data to arrive at each processing system at the same time.

In other words, the method disclosed in Patent Literature 2 cannot be used in the case where data arrives at each processing system at different timings.

In addition, in periodic computations, there is a case where operations such as that each processing system is in a standby state until each processing system transmits and receives a synchronization command are not applicable. In that case, the method disclosed in Patent Literature 2 cannot be used.

### CITATION LIST

### Patent Literature

Patent Literature 1: JP-A-2009-193504

Patent Literature 2: JP-A-58-99865

### SUMMARY OF INVENTION

### Technical Problem

An object of the invention is to synchronize operations in each of a plurality of processing systems in a multiplex system even when timings at which data is input to each of the plurality of processing systems are not synchronized.

### Solution to Problem

A multiplex system according to the present invention includes a plurality of input units to which data is input respectively.

Each of the plurality of input units outputs an input notification at an input timing at which the data is input, and outputs the data at a synchronization timing which is a timing of a later one of the input timing and a timing at which an input notification is output from another input unit.

### Advantageous Effects of Invention

According to the invention, data is output synchronously from each of a plurality of input units in a multiplex system even when the timings at which data is input to each of the plurality of input units are not synchronized. Therefore, it is possible to synchronize operations of each of a plurality of processing systems even when the timings at which data is input to each of the plurality of processing systems are not synchronized.

### BRIEF DESCRIPTION OF DRAWINGS

FIG. 1 is a structural diagram of a multiplex system 100 in Embodiment 1.

FIG. 2 is a functional structural diagram of an input unit 110 in Embodiment 1.

FIG. 3 is a structural diagram of a computing circuit 220 in Embodiment 1.

FIG. 4 is a functional structural diagram of an output unit 130 in Embodiment 1.

FIG. 5 is a flowchart of a multiplexing method in Embodiment 1.

FIG. 6 is a flowchart of an input process (S110) in Embodiment 1.

FIG. 7 is a flowchart of a computing process (S120) in Embodiment 1.

FIG. 8 is a flowchart of an output process (S130) in Embodiment 1.

FIG. 9 is a functional structural diagram of an input unit 110 in Embodiment 2.

FIG. 10 is a flowchart of an input process (S110) in Embodiment 2.

FIG. 11 is a structural diagram of a multiplex system 100 in Embodiment 3.

FIG. 12 is a functional structural diagram of a specification unit 140 in Embodiment 3.

FIG. 13 is a flowchart of a multiplexing method in Embodiment 3.

FIG. 14 is a flowchart of a specification process (S140) in Embodiment 3.

### DESCRIPTION OF EMBODIMENTS

### Embodiment 1

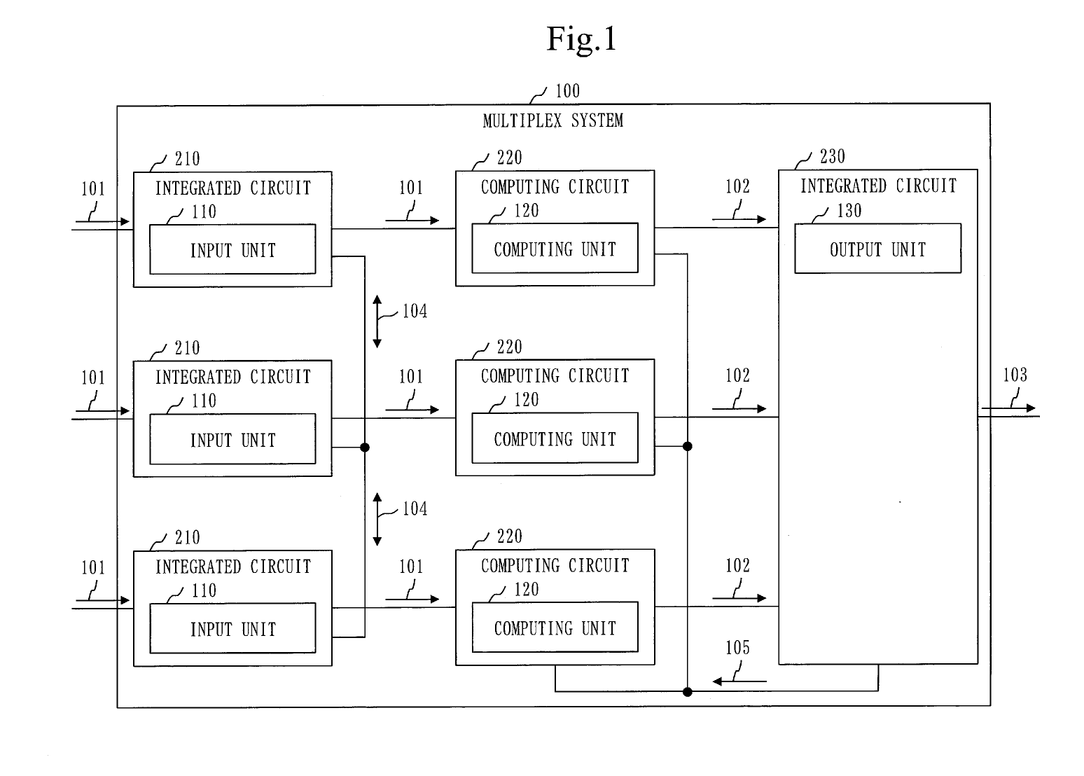

The multiplex system 100 having a plurality of processing systems will be described with reference to FIGS. 1 to 8.

Description of the Structure

A structure of the multiplex system 100 will be described with reference to FIG. 1.

The multiplex system 100 includes a plurality of integrated circuits 210, a plurality of computing circuits 220 and an integrated circuit 230.

Specifically, the integrated circuits 210 and the integrated circuit 230 are circuits called LSI (Large Scale Integration). A computing circuit 220 is a circuit having a processor.

The plurality of integrated circuits 210, the plurality of computing circuits 220 and the integrated circuit 230 are connected via a signal line.

Specifically, the plurality of integrated circuits 210 are connected to each other, and the plurality of computing circuits 220 are connected to the integrated circuit 230. In addition, the n-th integrated circuit 210 is connected to the n-th computing circuit 220.

An integrated circuit 210 functions as an input unit 110, a computing circuit 220 functions as a computing unit 120, and the integrated circuit 230 functions as an output unit 130.

That is, the multiplex system 100 includes “units” such as a plurality of input units 110, a plurality of computing units 120, and an output unit 130 as elements of a functional structure. The function of “unit” is realized by hardware referred to as a circuit. The function of “unit” will be described later.

The input units 110 and the computing units 120 are associated one to one, and a pair of an input unit 110 and a computing unit 120 constitutes a processing system.

That is, the n-th input unit 110 and the n-th computing unit 120 are associated one to one, and the pair of the n-th input unit 110 and the n-th computing unit 120 constitutes the n-th processing system. The n-th input unit 110 is an input unit 110 of the n-th integrated circuit 210, and the n-th computing unit 120 is a computing unit 120 of the n-th computing circuit 220.

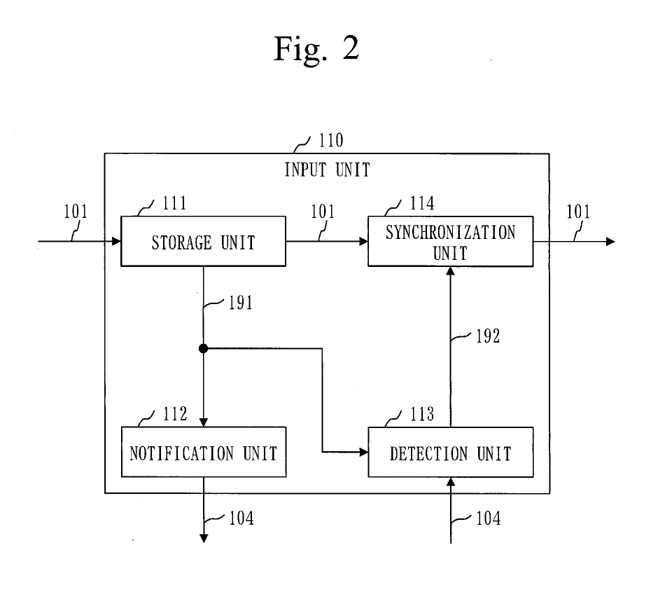

A functional structure of the input unit 110 will be described with reference to FIG. 2.

The input unit 110 includes a storage unit 111, a notification unit 112, a detection unit 113 and a synchronization unit 114 as elements of the functional structure. The functions of these units will be described later.

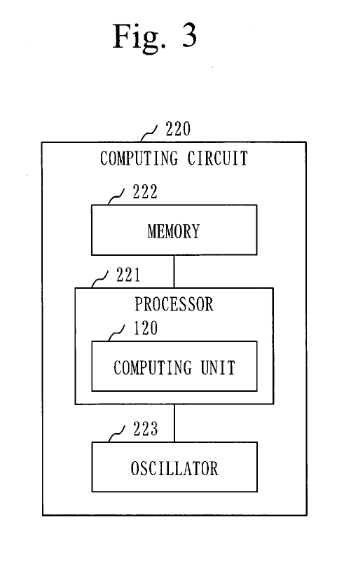

A structure of the computing circuit 220 will be described with reference to FIG. 3.

The computing circuit 220 includes a processor 221, a memory 222, and an oscillator 223. The processor 221 is connected to the memory 222 and the oscillator 223 via a signal line.

The processor 221 is an integrated circuit which performs a process. To be specific, a processor 901 is a CPU (Central Processing Unit).

The memory 222 is a nonvolatile storage device. To be specific, the memory 222 is a ROM (Read Only Memory).

The oscillator 223 is a circuit which generates a clock signal. To be specific, the oscillator 223 is a crystal oscillator.

The oscillator 223 is a clock source of the processor 221. The processor 221 operates using a clock frequency of the oscillator 223 as an operation frequency. The processor 221 may also operate by multiplying the clock frequency of the oscillator 223 and using the multiplied clock frequency as the operation frequency.

The oscillator 223 has an individual difference. Specifically, a deviation within ±100 PPM occurs in the accuracy of the oscillator 223. As a result, when a rated frequency of the oscillator 223 is 100 MHz, a difference of ±10 KHz (kilohertz) occurs in the oscillator 223. That is, the clock frequency in a faster oscillator 223 is 100 MHz+10 KHz, and the clock frequency in a slower oscillator 223 is 100 MHz-10 KHz. Therefore, a difference occurs in the operation frequencies among processors 221.

A computation program is stored in the memory 222. A plurality of computations and an order of the computations are defined in the computation program.

The processor 221 operates in accordance with the clock signal generated by the oscillator 223, and executes the computation program stored in the memory 222. The processor 221 functions as the computing unit 120.

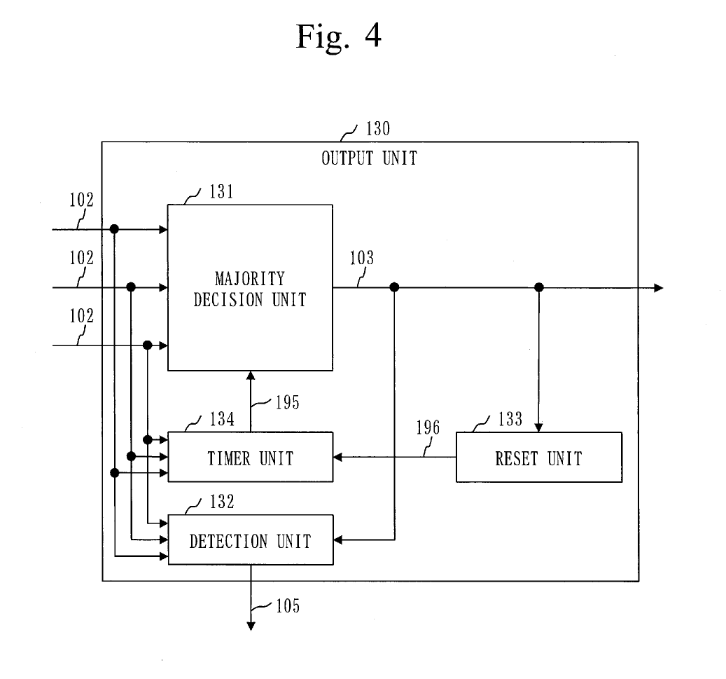

A functional structure of the output unit 130 will be described with reference to FIG. 4.

The output unit 130 includes a majority decision unit 131, a detection unit 132, a reset unit 133 and a timer unit 134 as elements of the functional structure. The functions of these units will be described later.

Description of Operation

The operation of the multiplex system 100 is equivalent to a multiplexing method.

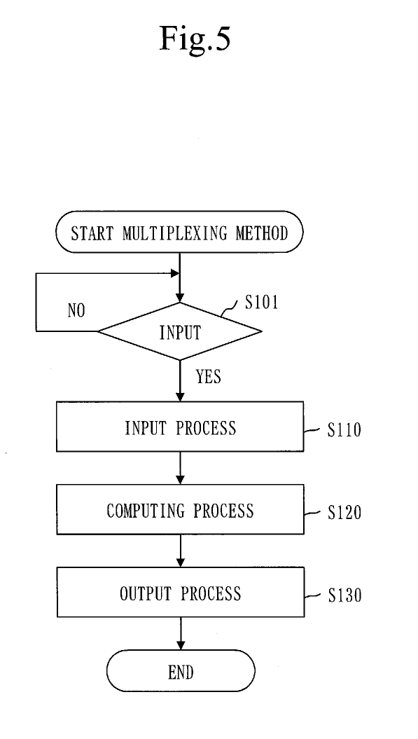

The multiplexing method will be described with reference to FIG. 5.

In step S101, when data is input to each of the plurality of input units 110, the process proceeds to step S110. Data input to each input unit 110 is referred to as input data 101.

The same input data 101 is input to each input unit 110. In addition, the timings at which the input data 101 is input to each input unit 110 can deviate from one another. In other words, the input data 101 can be input to each input unit 110 without synchronizing the timings at which the input data 101 is input to each input unit 110.

Step S110 is an input process.

Each of the plurality of input units 110 outputs an input notification 104 at the input timing at which the input data 101 is input, and outputs the input data 101 at the synchronization timing. The synchronization timing is the later one of the input timing and the timings at which the input notification 104 is output from other input units 110.

Specifically, each input unit 110 outputs the input notification 104 and the input data 101 as follows.

The input data 101 is input to the storage unit 111, and the storage unit 111 inputs the input data 101.

The notification unit 112 detects a timing at which the input data 101 is stored in the storage unit 111 as an input timing and outputs the input notification 104.

The detection unit 113 detects the later one of the input timing and timings at which the input notification 104 is output from other input units 110 as the synchronization timing.

The synchronization unit 114 reads the input data 101 from the storage unit 111 and outputs the input data 101 when the synchronization timing is detected.

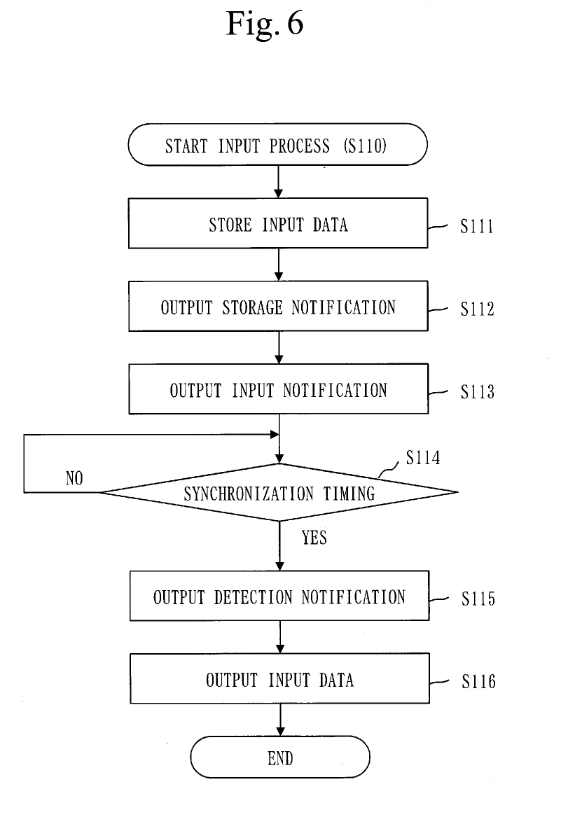

A procedure of the input process (S110) will be described with reference to FIG. 6.

In step S111, the input data 101 is input to the storage unit 111. Then the storage unit 111 stores the input data 101.

In step S112, the storage unit 111 outputs a storage notification 191. The storage notification 191 is a signal to notify that the input data 101 has been stored in the storage unit 111.

The output storage notification 191 is input to the notification unit 112 and the detection unit 113.

In step S113, the notification unit 112 outputs the input notification 104. The input notification 104 is a signal to notify that the input data 101 has been input to the input unit 110.

The output input notification 104 is input to other input units 110.

In step S114, the detection unit 113 detects a synchronization timing.

The synchronization timing is the later one of a timing at which the storage notification 191 output from the storage unit 111 is input and the timings at which the input notification 104 output from other input units 110 is input.

Specifically, the detection unit 113 detects the synchronization timing as follows. In the following description, the other input units 110 are a second input unit 110 and a third input unit 110.

The detection unit 113 has first to third flags.

The value of the first flag changes from 0 to 1 when the storage notification 191 is input. The value of the second flag changes from 0 to 1 when the input notification 104 of the second input unit 110 is input, and the value of the third flag changes from 0 to 1 when the input notification 104 of the third input unit 110 is input.

The detection unit 113 detects the timing at which the values of the first to the third flags all become 1 as the synchronization timing.

When the synchronization timing is detected, the process proceeds to step S115.

In step 5115, the detection unit 113 outputs a detection notification 192. The detection notification 192 is a signal to notify that the synchronization timing has been detected.

The output detection notification 192 is input to the synchronization unit 114.

In step S116, the synchronization unit 114 reads the input data 101 from the storage unit 111. Then the synchronization unit 114 outputs the read input data 101.

The input data 101 output from the synchronization unit 114 of the n-th input unit 110 is input to the n-th computing unit 120.

Returning to FIG. 5, the description will be continued from step S120.

Step S120 is a computing process.

In step S120, the plurality of computing units 120 start computations when the input data 101 output from the plurality of input units 110 is input. That is, the n-th computing unit 120 starts a computation when the input data 101 output from the n-th input unit 110 is input.

Then each of the plurality of computing units 120 outputs a computation result 102.

However, the computing unit 120 which is notified of an error from the output unit 130 does not perform the computation and does not output the computation result 102. This is because the processing system including the computing unit 120 notified of an error is considered out of order.

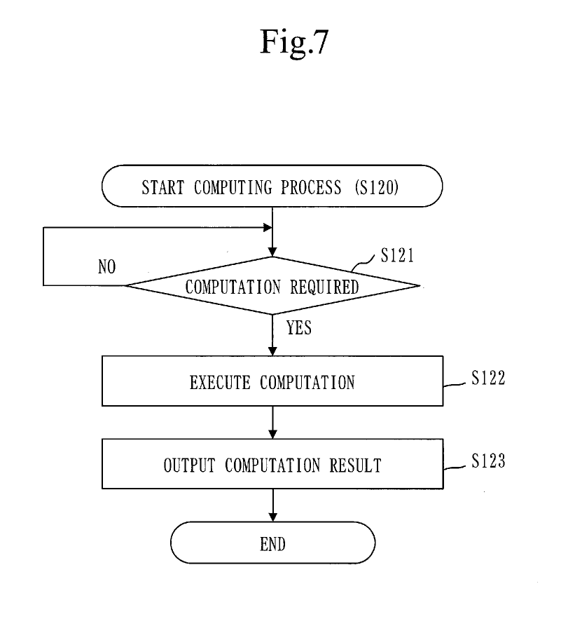

A procedure of the computing process (S120) will be described with reference to FIG. 7.

In step S121, the computing unit 120 determines whether a computation is required or not.

To be specific, the computing unit 120 determines whether a computation is required or not as follows.

A computation flag is stored in the memory 222. The value of the computation flag changes from 0 to 1 when an error is notified.

When the value of the computation flag is 0, the computing unit 120 determines that a computation is required. When the value of the computation flag is 1, the computing unit 120 determines that a computation is not required.

When it is determined that a computation is required, the process proceeds to step S122.

In step S122, the computing unit 120 performs a computation using the input data 101 which is input. To be specific, the processor 221 which functions as the computing unit 120 executes a computation program stored in the memory 222.

When the computation ends, the process proceeds to step S123.

In step S123, the computing unit 120 outputs the computation result 102. The computation result 102 is data showing a result obtained by the computation.

The output computation result 102 is input to the output unit 130.

Returning to FIG. 5, the description will be continued from step S130.

Step S130 is an output process.

In step S130, the output unit 130 selects a computation result 102 from a plurality of computation results 102 obtained by the plurality of computing units 120 and outputs data having the same content as the selected computation result 102. The data output from the output unit 130 is referred to as output data 103.

The output unit 130 notifies the computing unit 120 which has obtained an unselected computation result 102 of an error.

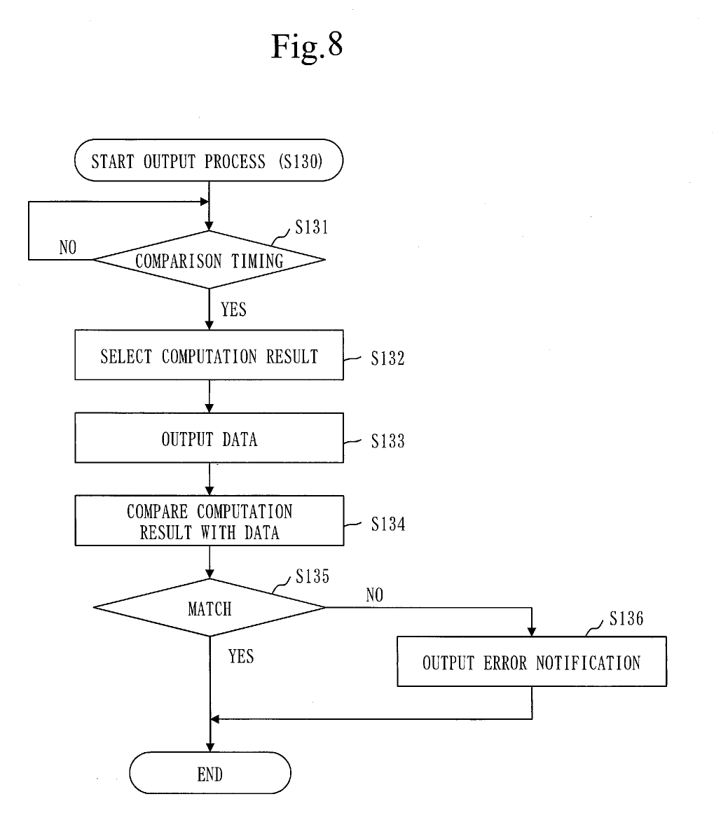

A procedure of the output process (S130) will be described with reference to FIG. 8.

In step 5131, the majority decision unit 131 detects a comparison timing of comparing the computation results 102.

The comparison timing is the faster one of the timing at which the computation results 102 output from the plurality of computing units 120 are input and a timing at which the comparison of the computation results 102 should have been completed.

The timing at which the comparison of the computation results 102 should have been completed is a timing at which a timeout notification 195 output from the timer unit 134 is input.

Specifically, the majority decision unit 131 detects the comparison timing as follows. In the following description, the plurality of computing units 120 are first to third computing units 120.

The computation results 102 output from the first to the third computing units 120 are input to the majority decision unit 131, the timer unit 134 and the detection unit 132.

The majority decision unit 131 has first to third flags. The value of the n-th flag changes from 0 to 1 when the computation result 102 output from the n-th computing unit 120 is input.

The timer unit 134 starts time measurement when the first computation result 102 of the computation results 102 output from the first to the third computing units 120 is input, and measures elapsed time elapsed since the input of the first computation result 102. Then the timer unit 134 outputs the timeout notification 195 when the elapsed time reaches a holding time. The timeout notification 195 is a signal to notify that the elapsed time has reached the holding time. The output timeout notification 195 is input to the majority decision unit 131. The holding time is a predetermined time. Specifically, the holding time is 1 millisecond.

The majority decision unit 131 detects a timing of the faster one of the timing at which the values of the first to the third flags all become 1 and the timing at which the timeout notification 195 is input as the comparison timing.

When the comparison timing is detected, the process proceeds to step S132.

In step 5132, the majority decision unit 131 takes a majority decision of the input computation results 102 and selects the majority computation results 102. The majority computation results 102 mean the computation results 102 selected by a majority decision.

In other words, in a case where the first to the third computation results 102 are input and the first computation result 102 and the second computation result 102 are a first value while the third computation result 102 is a second value, the majority decision unit 131 selects the first computation result 102 and the second computation result 102.

In step S133, the majority decision unit 131 outputs data having the same content as the selected computation results 102 as the output data 103.

The output data 103 is output to the outside of the multiplex system 100. In addition, the output data 103 is input to the detection unit 132 and the reset unit 133.

The reset unit 133 outputs a reset notification 196 when the output data 103 is input. The reset notification 196 is a signal to reset the measurement of elapsed time. The output reset notification 196 is input to the timer unit 134.

The timer unit 134 stops the measurement of elapsed time and resets the measured time to 0.

In step S134, the detection unit 132 compares the input computation results 102 with the input output data 103.

In step S135, the detection unit 132 determines whether the input computation results 102 and the input output data 103 match.

When at least one of the computation results 102 does not match the output data 103, the process proceeds to step S136.

In step S136, the detection unit 132 generates an error notification 105.

Specifically, the detection unit 132 specifies the computing units 120 of the input sources of the computation results 102 which do not match the output data 103, and generates the error notification 105 including identifiers which identify the specified computing units 120.

The error notification 105 is data to notify the computing units 120 from which a minority computation results 102 are obtained. The minority computation results 102 mean the computation results 102 which are not selected by the majority decision.

Then the detection unit 132 outputs the generated error notification 105. The output error notification 105 is input to each of the plurality of computing units 120.

The computing units 120 which are identified by the identifiers included in the error notification 105 do not perform computations next time and thereafter. That is, a computing unit 120 notified of an error does not perform a computation from next time and thereafter. This is because the processing system including the computing unit 120 notified of an error is considered out of order.

Effects of Embodiment 1

The multiplex system 100 can synchronize operations of each of the plurality of processing systems even when the timings at which data is input to each of the plurality of processing systems are not synchronized.

The plurality of input units 110 output the input data 101 at the synchronization timing. As a result, the input data 101 is input to the plurality of computing units 120 at the same timing.

The plurality of computing units 120 start computations at the timing at which the input data 101 is input. In other words, the timing at which the input data 101 is input is the timing at which execution of computations in the computation program is started.

As a result, the same input data 101 is input to the plurality of computing units 120 at the timing at which the same computation is executed even when a difference occurs in the operation frequencies of the plurality of computing units 120. Therefore, the plurality of computing units 120 can execute the same computation using the same input data 101. Then the plurality of computing units 120 can output the same computation result 102.

To be specific, the computation program is initiated when an internal timer of the processor 221 reaches a predetermined value. For example, the predetermined value is 0. In this case, by changing the value of the internal timer of the processor 221 to 0 at the timing at which the input data 101 is input, the computation programs are initiated at substantially the same time in the plurality of processors 221. The computation programs are initiated when the input data 101 is input even when the timings at which the computation programs are initiated slightly deviate from one another due to the difference in the operation frequencies among the processors 221. Therefore, the plurality of computing units 120 can execute the same computation using the same input data 101 as long as a trouble such as a failure does not occur in any of the processing systems. Then the plurality of computing units 120 can output the same computation result 102.

Since the value of the internal timer of the processor 221 reaches a predetermined value at the timing at which the input data 101 is input, the deviation of the timings at which the computations are started does not expand even when the operation frequencies differ among the processors 221. In a case where a cycle of inputting the input data 101 is several hundred milliseconds, the deviation of the accuracy of the oscillator 223 is within ±100 PPM and the operation frequency of the processor 221 is 100 MHz, the deviation of the timings at which the computations are completed is suppressed to about several hundred microseconds. This is because the computations are started at the timing at which the input data 101 arrives. Since the deviation of the timings at which the computations are completed is small, the amount of the computation results 102 of the computing units 120 retained by the output unit 130 can be small. In other words, it is possible to obtain an effect of requiring only a small storage area without being caught by a timeout.

Other Structures

The number of the processing systems included in the multiplex system 100 may be 2 or 4 or more besides 3.

### Embodiment 2

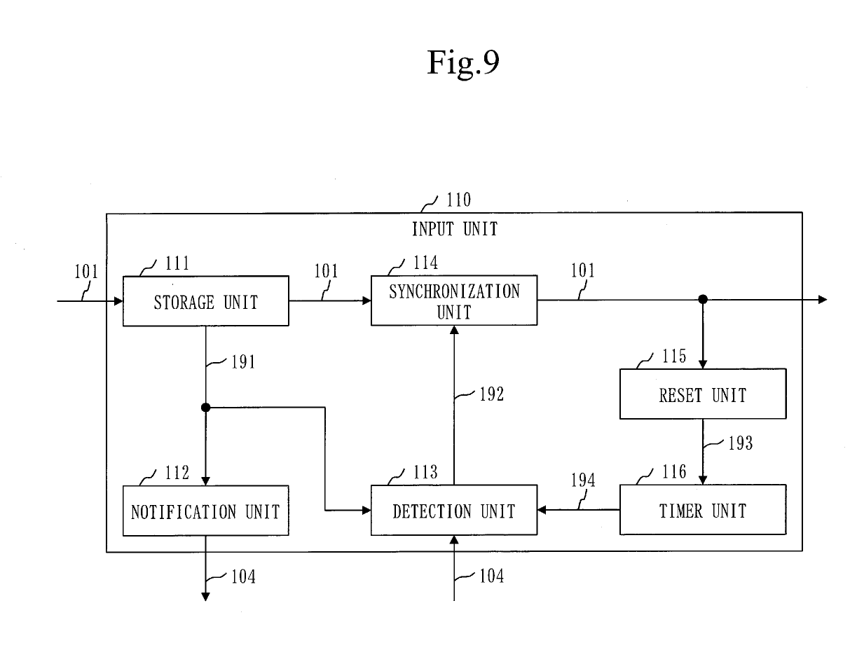

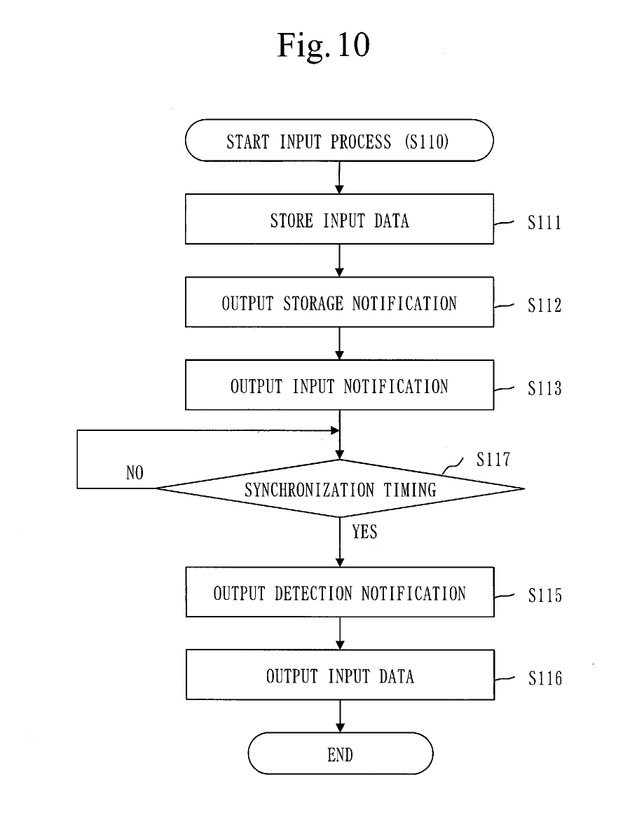

A mode where a failure that the input data 101 is not input to any one of the input units 110 is considered will be described with reference to FIG. 9 and FIG. 10. However, the description overlapping with that of Embodiment 1 will be omitted or simplified.

Description of the Structure

The structure of the multiplex system 100, the structure of the computing circuit 220 and the functional structure of the output unit 130 are the same as those in Embodiment 1.

A functional structure of the input unit 110 will be described with reference to FIG. 9.

The input unit 110 includes the reset unit 115 and the timer unit 116 besides the storage unit 111, the notification unit 112, the detection unit 113 and the synchronization unit 114 as elements of the functional structure.

The functions of the storage unit 111, the notification unit 112, the detection unit 113 and the synchronization unit 114 are the same as those in Embodiment 1. The functions of the reset unit 115 and the timer unit 116 will be described later.

Description of Operation

The procedure of the multiplexing method, the procedure of the computing process (S120) and the procedure of the output process (S130) are the same as those in Embodiment 1.

However, in the multiplexing method described with reference to FIG. 5, the input process (S110) differs from that of Embodiment 1 in the following aspects.

In step S110, each of the plurality of input units 110 outputs the input data 101 at a limit timing when the synchronization timing is not reached by the limit timing The limit timing is a timing at which the input of the input data 101 should have been completed.

The input process (S110) will be described with reference to FIG. 10.

The input process (S110) includes steps S111 to S113 and steps S115 to S117. Steps S111 to S113, step S115 and step S116 are basically the same as those in Embodiment 1.

In step S111, the storage unit 111 stores the input data 101.

In step S112, the storage unit 111 outputs the storage notification 191.

In step S113, the notification unit 112 outputs the input notification 104.

After step S113, the process proceeds to step S117.

In step S117, the detection unit 113 detects a preceding timing.

The preceding timing is the faster one of the synchronization timing and the limit timing.

As described in Embodiment 1, the synchronization timing is the later one of the timing at which the storage notification 191 output from the storage unit 111 is input and the timings at which the input notification 104 output from other input units 110 is input.

The method of detecting the synchronization timing is as described in step S114 in Embodiment 1.

A specific limit timing is a timing at which a time elapsed since the input data 101 which was input last time is output reaches an allowed time. The allowed time is a predetermined time.

Specifically, the detection unit 113 detects the limit timing as follows.

The input data 101 output last time from the synchronization unit 114 is input to the reset unit 115 besides the computing unit 120.

The reset unit 115 outputs a reset notification 193 when the input data 101 is input. The reset notification 193 is a signal to reset time measurement. The output reset notification 193 is input to the timer unit 116.

The timer unit 116 starts time measurement when the reset notification 193 is input, and measures elapsed time elapsed since the input of the reset notification 193. Then the timer unit 116 outputs a timeout notification 194 when the elapsed time reaches the allowed time. The timeout notification 194 is a signal to notify that the elapsed time reaches the allowed time. The output timeout notification 194 is input to the detection unit 113. The allowed time is a predetermined time. Specifically, the allowed time is 10 milliseconds.

The detection unit 113 detects a timing at which the timeout notification 194 is input as the limit timing.

When the limit timing or the synchronization timing is detected as the preceding timing, the process proceeds to step S115.

In step S115, the detection unit 113 outputs the detection notification 192, and the output detection notification 192 is input to the synchronization unit 114.

In step S116, the synchronization unit 114 outputs the input data 101, and the output input data 101 is input to the computing unit 120 and the reset unit 115.

The reset unit 115 outputs the reset notification 193 when the input data 101 is input, and the output reset notification 193 is input to the timer unit 116. The timer unit 116 resets the measured time to 0 and starts time measurement when the reset notification 193 is input.

### Effects of Embodiment 2

The plurality of input units 110 output the input data 101 at the limit timing at the latest. Therefore, the multiplex system 100 can continue operations even when a transfer path through which the input data 101 is transferred is disconnected in any of the input units 110.

### Embodiment 3

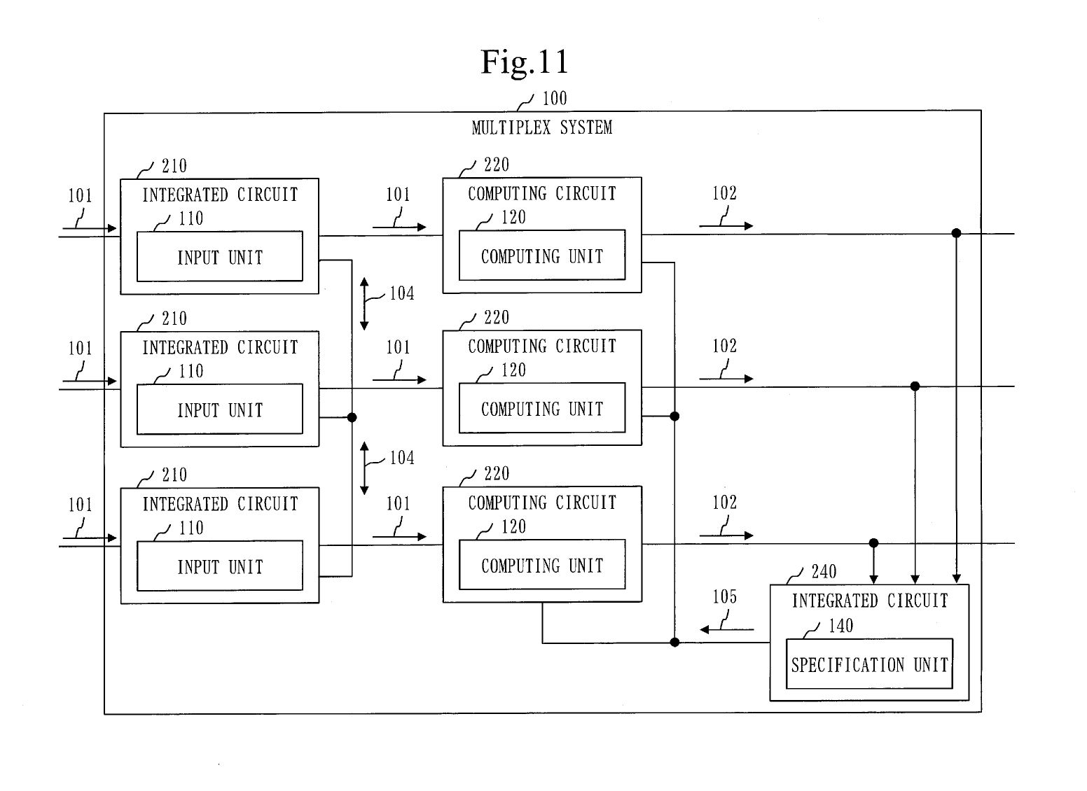

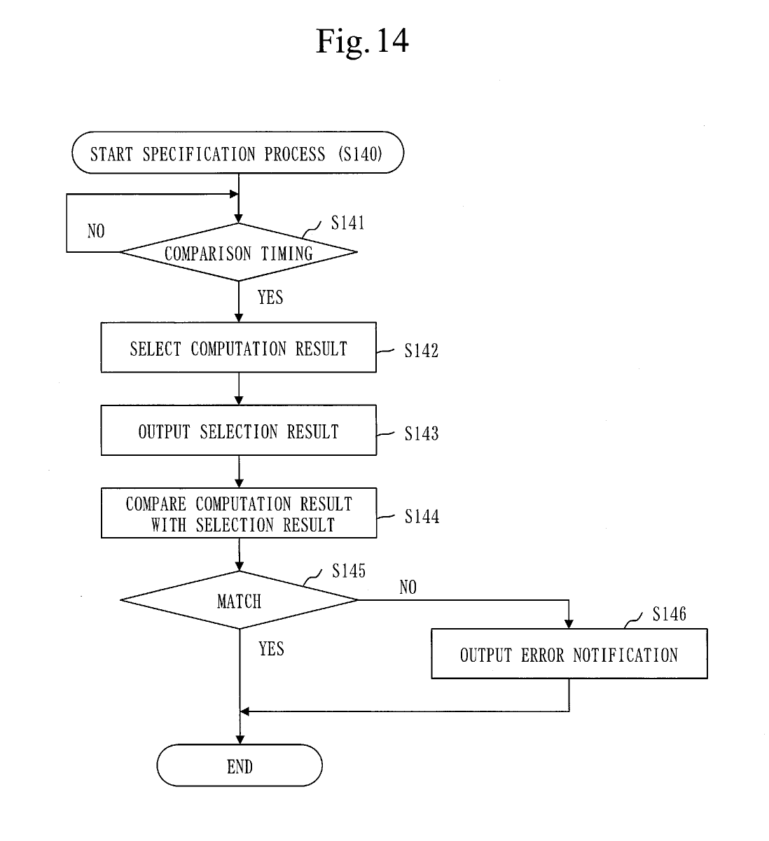

A mode where the plurality of computation results 102 are output to the outside will be described with reference to FIG. 11 and FIG. 14. However, the description overlapping with that of Embodiment 1 and that of Embodiment 2 will be omitted or simplified.

Description of the Structure

The structure of the multiplex system 100 will be described with reference to FIG. 11.

The multiplex system 100 includes a plurality of integrated circuits 210, a plurality of computing circuits 220 and an integrated circuit 240.

The integrated circuits 210 and the computing circuits 220 function as the input units 110 and the computing units 120 as described in Embodiment 1.

The integrated circuit 240 functions as a specification unit 140. In other words, the multiplex system 100 includes the specification unit 140 as an element of a functional structure. The function of the specification unit 140 will be described later.

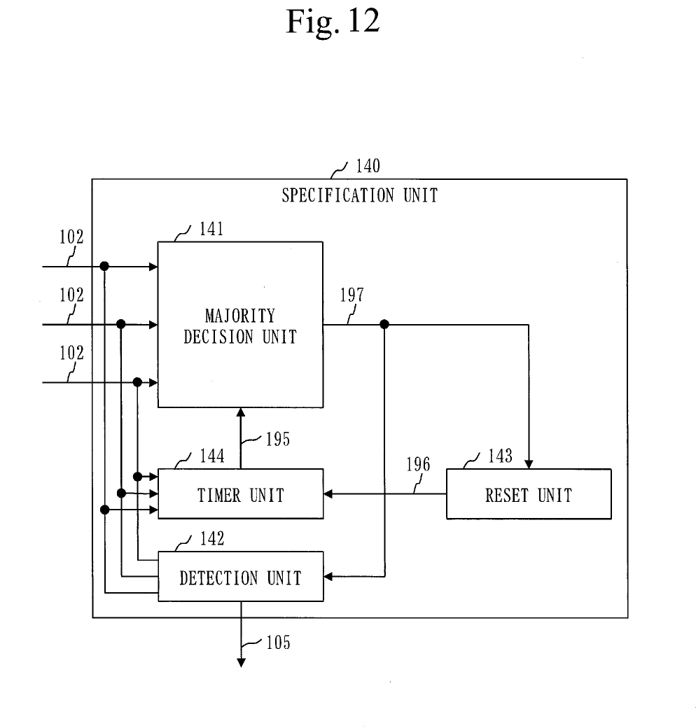

A functional structure of the specification unit 140 will be described with reference to FIG. 12.

The functional structure of the specification unit 140 is the same as the functional structure of the output unit 130 described in Embodiment 1.

That is, the specification unit 140 includes a majority decision unit 141, a detection unit 142, a reset unit 143 and a timer unit 144 as elements of the functional structure.

Description of Operation

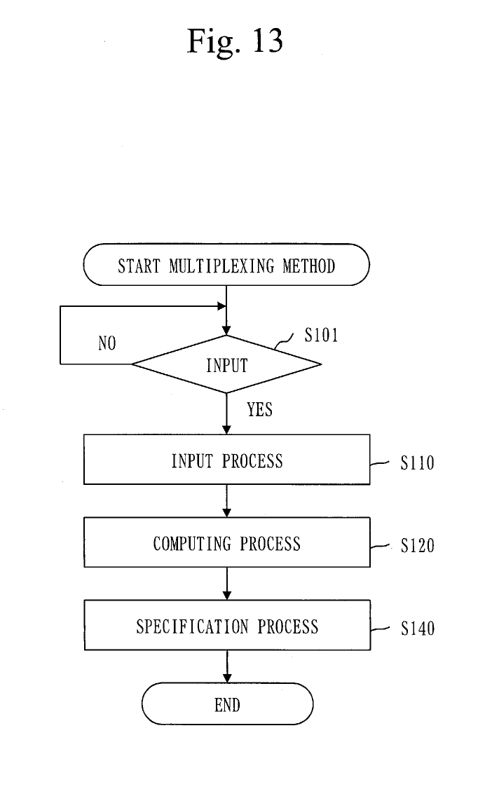

A multiplexing method will be described with reference to FIG. 13.

The multiplexing method includes step S101, step S110, step S120 and step S140.

Step S101, step S110 and step S120 are basically the same as those in Embodiment 1 or Embodiment 2. However, in the computing process (S120), the computation results 102 are output to the outside of the multiplex system 100. In addition, the computation results 102 are input to the specification unit 140.

Step S140 is a specification process.

In step S140, the specification unit 140 specifies the computing unit 120 which has obtained a computation result 102 not selected by a majority decision among the plurality of computing units 120.

Then the specification unit 140 notifies the specified computing unit 120 of an error, and the computing unit 120 notified of an error does not perform a computation next time and thereafter.

A procedure of the specification process (S140) will be described with reference to FIG. 14.

The specification process (S140) includes steps S141 to S146. Steps S141 to S146 are equivalent to steps S131 to S136 described with reference to FIG. 8 in Embodiment 1.

In step S141, the majority decision unit 141 detects a comparison timing of comparing the computation results 102. The method of detecting the comparison timing is as described in Embodiment 1.

In step S142, the majority decision unit 141 takes a majority decision of the input computation results 102 and selects the majority computation results 102.

In step S143, the majority decision unit 141 outputs the selected computation results 102. The computation results 102 output from the majority decision unit 141 is referred to as a selection result 197. The selection result 197 is input to the detection unit 142 and the reset unit 143.

The reset unit 143 outputs a reset notification 196 when the selection result 197 is input, and the output reset notification 196 is input to the timer unit 134. The timer unit 134 stops the measurement of elapsed time and resets the measured time to 0.

In step S144, the detection unit 142 compares the input computation results 102 with the input selection result 197.

In step S145, the detection unit 142 determines whether the input computation results 102 and the input selection result 197 match.

When at least one of the computation results 102 does not match the selection result 197, the process proceeds to step S146.

In step S146, the detection unit 142 generates the error notification 105 and outputs the generated error notification 105. The output error notification 105 is input to each of the plurality of computing units 120. The content of the error notification 105 and the method of generating the error notification 105 are as described in Embodiment 1.

The computing units 120 which are identified by the identifiers included in the error notification 105 do not perform computations next time and thereafter. That is, a computing unit 120 notified of an error does not perform a computation from next time and thereafter.

Effects of Embodiment 3

Comparing with the time from the input of the input data 101 from the outside to the output of the output data 103 to the outside in Embodiment 1 and Embodiment 2, the time from the input of the input data 101 from the outside to the output of the computation results 102 to the outside in Embodiment 3 is shorter. In other words, according to Embodiment 3, a response time of the multiplex system 100 to the outside can be shortened.

Supplement of Embodiments

Each embodiment is merely an example of a preferable mode, and it does not intend to limit the technical scope of the invention. Each embodiment may be practiced partially or may be practiced combined with another embodiment.

The procedures described using flowcharts and the like are examples of the procedures of the system and the method.

“Unit”, which is an element of a functional structure, may be read as “circuit”.

### REFERENCE SIGNS LIST

100: multiplex system, 101: input data, 102: computation result, 103: output data, 104: input notification, 105: error notification, 110: input unit, 111: storage unit, 112: notification unit, 113: detection unit, 114: synchronization unit, 115: reset unit, 116: timer unit, 120: computing unit, 130: output unit, 131: majority decision unit, 132: detection unit, 133: reset unit, 134: timer unit, 140: specification unit, 141: majority decision unit, 142: detection unit, 143: reset unit, 144: timer unit, 191: storage notification, 192: detection notification, 193: reset notification, 194: timeout notification, 195: timeout notification, 196: reset notification, 197: selection result, 210: integrated circuit, 220: computing circuit, 221: processor, 222: memory, 223: oscillator, 230: integrated circuit, 240: integrated circuit

1-11. (canceled)

12. A multiplex system comprising a plurality of input circuits to which data is input respectively,
wherein each of the plurality of input circuits outputs an input notification at an input timing at which the data is input, and when a synchronization timing is reached by a limit timing, outputs the data at the synchronization timing, and when the synchronization timing is not reached by the limit timing, outputs the data at the limit timing, the synchronization timing being a timing of a later one of the input timing and a timing at which an input notification is output from another input circuit.

13. The multiplex system according to claim 12,
wherein the limit timing is a timing at which a time elapsed since previous input data is output reaches an allowed time.

14. The multiplex system according to claim 13,
wherein each of the plurality of input circuits includes:
a storage circuit to which data is input and in which the data is stored;
a notification circuit to detect a timing at which the data is stored in the storage circuit as the input timing and to output an input notification;
a detection circuit which is an element to detect the timing of the later one of the input timing and the timing at which the input notification is output from the other input circuit as the synchronization timing, and an element to detect a preceding timing which is a timing of a faster one of the synchronization timing and the limit timing; and
a synchronization circuit to read the data from the storage circuit and to output the data when the preceding timing is detected.
